(19) United States
(12) Patent Application Publication
(10) Pub. No.: US 2017/0141510 A1
(43) Pub. Date: May 18, 2017

(54) ELECTRICAL CONNECTION WEATHERPROOFING DEVICE

(71) Applicant: Charles Lacey, McKinney, TX (US)

(72) Inventor: Charles Lacey, McKinney, TX (US)

(21) Appl. No.: 15/237,790

(22) Filed: Aug. 16, 2016

Related U.S. Application Data
(60) Provisional application No. 62/182,134, filed on Jun. 19, 2015.

(51) Int. Cl. H01R 13/52

(52) U.S. Cl. CPC H01R 13/5219

(57) ABSTRACT

In some embodiments, an electrical connection weatherproofing device, for use with an electrical connector system having a female electrical connector and a male electrical connector, may include a body forming a first sealing surface and a second sealing surface. A first connection slot and a second connection slot may be disposed within the body. Preferably, the first connection slot and the second connection slot may be complementary in shape to the shape of one or more prongs of a male electrical connector of an electrical connector system with which the device is to be used with. By inserting the male prongs of the male electrical connector through one or more connection slots of the device and into one or more slots of a female electrical connector, the device may be engaged to the electrical connector system with the device forming a seal between the female and male electrical connectors.

### CROSS REFERENCE TO RELATED APPLICATIONS

This application claims priority to and the benefit of the filing date of U.S. Provisional Application No. 62/182,134, filed on Jun. 19, 2015, entitled “Device That Weatherproofs Electrical Cord Connections”, which is hereby incorporated by reference in its entirety.

### FIELD OF THE INVENTION

This patent specification relates to the field of electrical weatherproofing devices. More specifically, this patent specification relates to devices configured to weatherproof electrical connections from dirt, water, and other contaminants.

### BACKGROUND

Electrical connectors are utilized in a wide range of environments and are typically found on power cords, power outlets, and the like. In order to maintain safety and efficiency, these connectors or connections must be shielded from dirt, water, mud, pest debris, and other containments. While some power cords attempt to solve this problem with a mating surface that is pressed against a connected power cord or outlet surface, this mating surface and its effectiveness deteriorates over time and use. This deterioration results in the possibility of the introduction of contaminants into the electrical connection. In outdoor and construction environments where power cords and power cord extensions are often utilized, this introduction of contaminants can result in injury and equipment damage.

Therefore, a need exists for novel electrical weatherproofing devices. There is a further need novel devices configured to weatherproof electrical connections from dirt, water, and other contaminants. Finally, there exists a need for novel electrical connection weatherproofing devices which are able to prevent the introduction of contaminants into electrical connections thereby preventing injury and equipment damage.

### BRIEF SUMMARY OF THE INVENTION

An electrical connection weatherproofing device is provided. The device may be used with any type of electrical connector system which may include a female electrical connector and a male electrical connector. As is common in electrical connector systems, the female and male electrical connectors may be configured to be removably coupled together by inserting one or more prongs of the male electrical connector in to one or more complimentary shaped slots of the female electrical connector.

In some embodiments, the device may include a body forming a first sealing surface and a second sealing surface. A first connection slot and a second connection slot may be disposed within the body. Preferably, the first connection slot and the second connection slot may be complementary in shape to the shape of one or more prongs of a male electrical connector of an electrical connector system with which the device is to be used with. By inserting one or more male prongs of the male electrical connector through one or more connection slots of the device and into one or more slots of the female electrical connector, the device may be engaged to the electrical connector system with the device forming a seal between the female and male electrical connectors.

In further embodiments, the device may be used with an electrical connection system having three male prongs. The device may further include a third connection slot, and the third connection slot may be complementary in shape to the shape of one of the prongs of the male electrical connector of the electrical connector system with which the device is to be used with.

In still further embodiments, the device may include an electrical connector coupling which may be used to couple the body of the device to the electrical connector system. The electrical connector coupling may be formed by a length of material which may be coupled to the body at a first end and coupled to the electrical connector system, such as to a female electrical connector, male electrical connector, and/or wiring at a second end.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a front perspective view of an example of an electrical connection weatherproofing device according to various embodiments described herein.

FIG. 2 illustrates a rear perspective view of an example of an electrical connection weatherproofing device according to various embodiments described herein.

FIG. 3 shows a perspective view of the example electrical connection weatherproofing device of FIG. 1 and FIG. 2 positioned with an electrical connector system which includes a female electrical connector and a male electrical connector according to various embodiments described herein.

FIG. 4 depicts a perspective view of the example electrical connection weatherproofing device of FIG. 1, FIG. 2, and FIG. 3 engaged with the electrical connector system of FIG. 3 according to various embodiments described herein.

FIG. 5 illustrates a front perspective view of a further example of an electrical connection weatherproofing device according to various embodiments described herein.

FIG. 6 shows a rear perspective view of a further example of an electrical connection weatherproofing device according to various embodiments described herein.

FIG. 7 depicts a perspective view of the example electrical connection weatherproofing device of FIG. 5 and FIG. 6 positioned with an electrical connector system which includes a female electrical connector and a male electrical connector according to various embodiments described herein.

FIG. 8 illustrates a perspective view of the example electrical connection weatherproofing device of FIG. 5, FIG. 6, and FIG. 7 engaged with the electrical connector system of FIG. 7 according to various embodiments described herein.

FIG. 9 shows a front perspective view of an alternative example of an electrical connection weatherproofing device according to various embodiments described herein.

FIG. 10 depicts a rear perspective view of an alternative example of an electrical connection weatherproofing device according to various embodiments described herein.

FIG. 11 illustrates a perspective view of the example electrical connection weatherproofing device of FIG. 9 and FIG. 10 positioned with an electrical connector system which includes a female electrical connector and a male electrical connector according to various embodiments described herein.

FIG. 12 shows a perspective view of the example electrical connection weatherproofing device of FIG. 9, FIG. 10, and FIG. 11 engaged with the electrical connector system of FIG. 11 according to various embodiments described herein.

FIG. 13 depicts a front perspective view of a further alternative example of an electrical connection weatherproofing device according to various embodiments described herein.

FIG. 14 illustrates a rear perspective view of a further alternative example of an electrical connection weatherproofing device according to various embodiments described herein.

FIG. 15 shows a perspective view of the example electrical connection weatherproofing device of FIG. 13 and FIG. 14 positioned with an electrical connector system which includes a female electrical connector and a male electrical connector according to various embodiments described herein.

FIG. 16 depicts a perspective view of the example electrical connection weatherproofing device of FIG. 13, FIG. 14, and FIG. 15 engaged with the electrical connector system of FIG. 15 according to various embodiments described herein.

FIG. 17 illustrates an elevation view of an example of an electrical connection weatherproofing device according to various embodiments described herein.

FIG. 18 shows an elevation view of an example of a male electrical connector according to various embodiments described herein.

FIG. 19 depicts an elevation view of an example of an electrical connection weatherproofing device configured for use with a type A electrical connector system according to various embodiments described herein.

FIG. 20 illustrates an elevation view of an example of an electrical connection weatherproofing device configured for use with a type B electrical connector system according to various embodiments described herein.

FIG. 21 shows an elevation view of an example of an electrical connection weatherproofing device configured for use with a type C electrical connector system according to various embodiments described herein.

FIG. 22 depicts an elevation view of an example of an electrical connection weatherproofing device configured for use with a type D electrical connector system according to various embodiments described herein.

FIG. 23 illustrates an elevation view of an example of an electrical connection weatherproofing device configured for use with a type E electrical connector system according to various embodiments described herein.

FIG. 24 shows an elevation view of an example of an electrical connection weatherproofing device configured for use with a type F electrical connector system according to various embodiments described herein.

FIG. 25 depicts an elevation view of an example of an electrical connection weatherproofing device configured for use with a type G electrical connector system according to various embodiments described herein.

FIG. 26 illustrates an elevation view of an example of an electrical connection weatherproofing device configured for use with a type H electrical connector system according to various embodiments described herein.

FIG. 27 shows an elevation view of an example of an electrical connection weatherproofing device configured for use with a type I electrical connector system according to various embodiments described herein.

FIG. 28 depicts an elevation view of an example of an electrical connection weatherproofing device configured for use with a type J electrical connector system according to various embodiments described herein.

FIG. 29 illustrates an elevation view of an example of an electrical connection weatherproofing device configured for use with a type K electrical connector system according to various embodiments described herein.

FIG. 30 shows an elevation view of an example of an electrical connection weatherproofing device configured for use with a type L electrical connector system according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

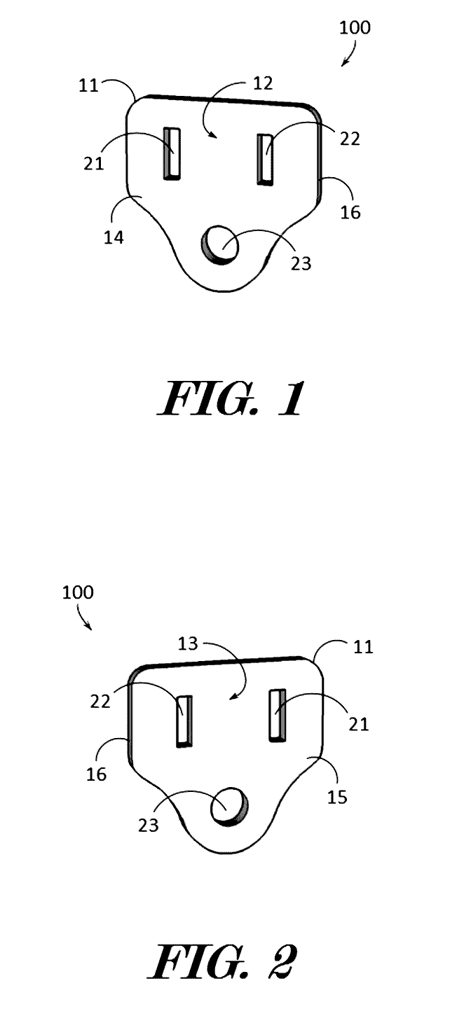

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, “third”, etc. are used herein to describe various elements, these elements should not be limited by these terms. These terms are only used to distinguish one element from another element. For example, the first element may be designated as the second element, and the second element may be likewise designated as the first element without departing from the scope of the invention.

New devices configured to weatherproof electrical connections from dirt, water, and other contaminants are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

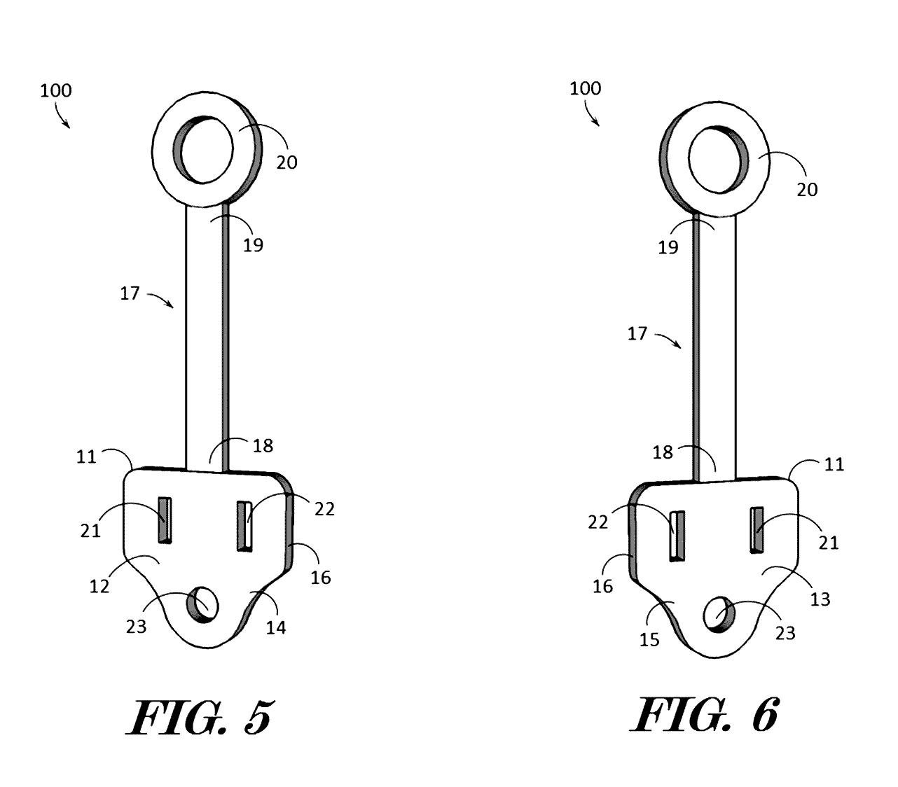

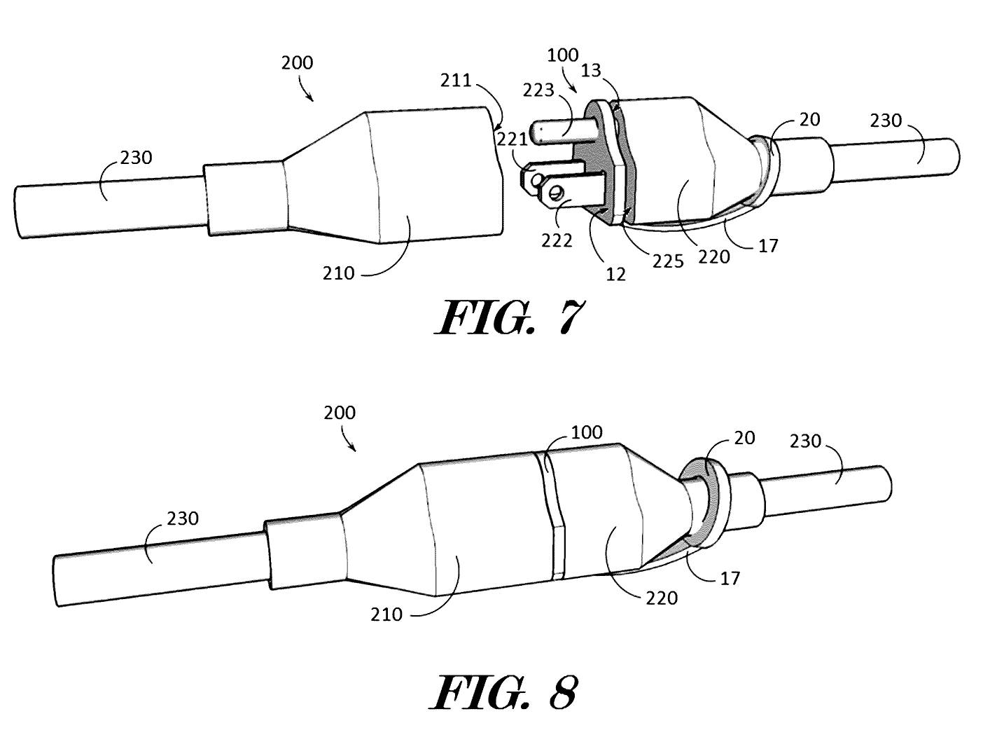

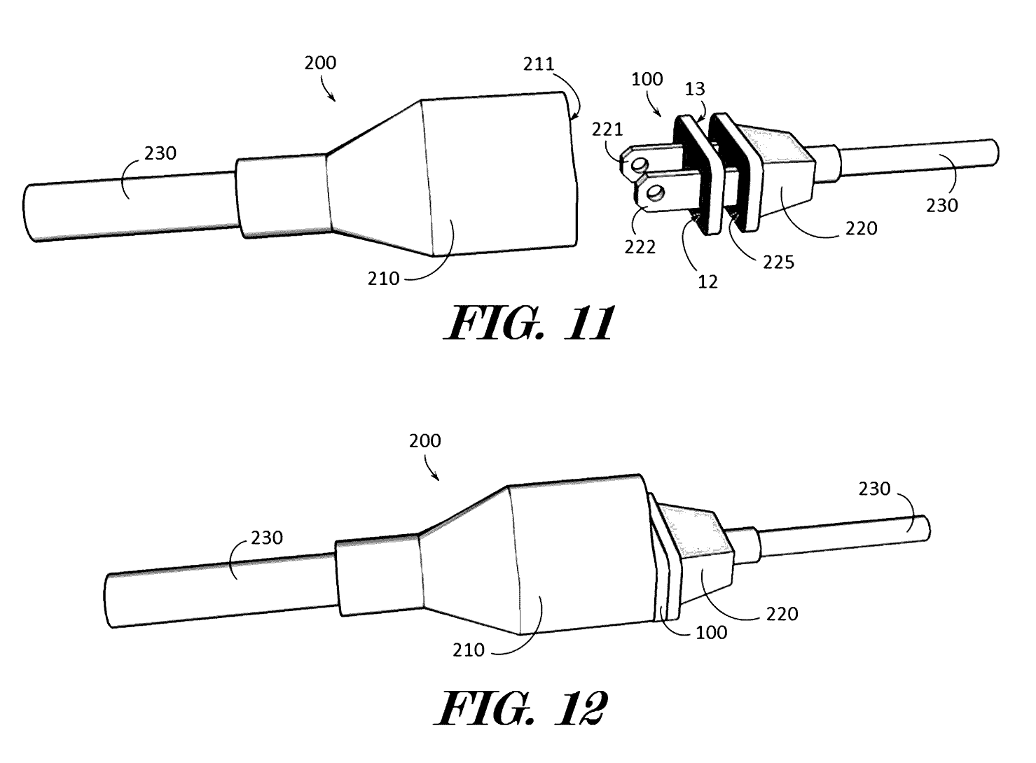

The present invention will now be described by example and through referencing the appended figures representing preferred and alternative embodiments. FIGS. 1-4 illustrate examples of an electrical connection weatherproofing device (“the device”) 100 according to various embodiments. The device 100 may be used with an electrical connector system 200 (FIGS. 5-12) which may include a female electrical connector 210 (FIGS. 5-12) and a male electrical connector 220 (FIGS. 5-12). The female 210 and male 220 electrical connectors may be configured to be removably coupled together by inserting one or more prongs 221, 222, 223, (FIGS. 5, 7, 9, 11) of the male electrical connector 220 in to one or more complimentary shaped slots of the female electrical connector 210.

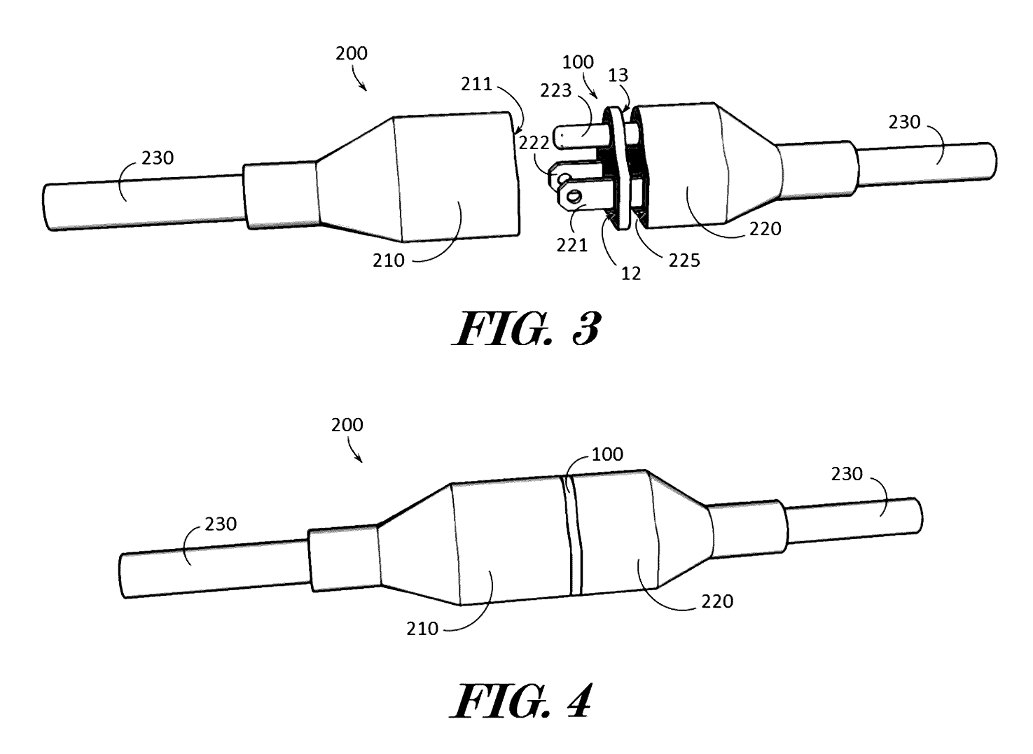

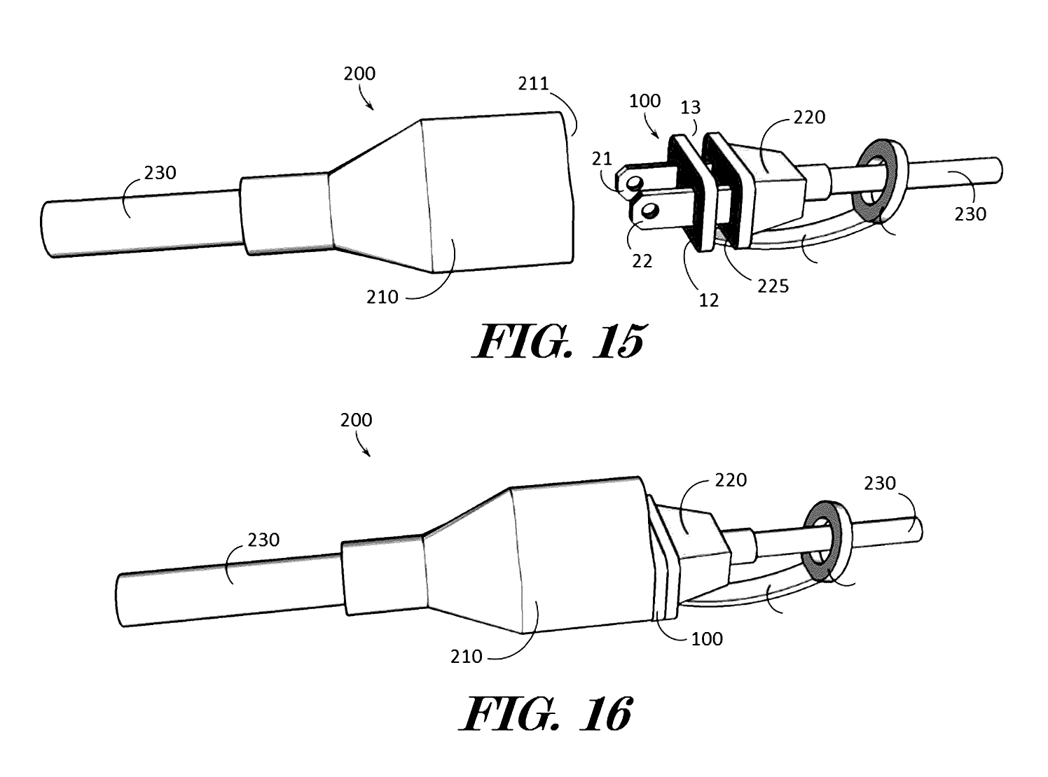

As perhaps best shown in the examples of FIGS. 1, 2, 5, 6, 9, 10, 13, and 14, the device 100 may comprise a body 11 forming a first sealing surface 12 and a second sealing surface 13. A first connection slot 21 and a second connection slot 22 may be disposed within the body 11. Preferably, the first connection slot 21 and the second connection slot 22 may be complementary in shape to the shape of one or more prongs 221, 222, 223, of a male electrical connector 220 of an electrical connector system 200 with which the device 100 is to be used with. Optionally, the device 100 may comprise a third connection slot 23, and the third connection slot 23 may be complementary in shape to the shape of one or more prongs 221, 222, 223, of a male electrical connector 220 of an electrical connector system 200 with which the device 100 is to be used with. By inserting one or more male prongs 221, 222, 223, of the male electrical connector 220 through one or more connection slots 21, 22, 23, of the device 100 and into one or more slots of the female electrical connector 210, the device 100 may be engaged to the electrical connector system 200 with the device 100 forming a seal between the female 210 and male 220 electrical connectors as perhaps best shown in FIGS. 3, 4, 7, 8, 11, 12, 15, and 16.

In some embodiments, the body 11 may be generally planar in shape to form a generally planar shaped first sealing surface 12 and second sealing surface 13. Preferably, the first sealing surface 12 and second sealing surface 13 may be positioned on opposing sides of the body 11 and the first sealing surface 12 may be generally parallel to the second sealing surface 13. In alternative embodiments, all or portions of the first sealing surface 12 may be angled towards or away from the second sealing surface 13. In still further embodiments, all or portions of the first sealing surface 12 and/or the second sealing surface 13 may be concave curved planar, convex curved planar, or any other shape all or portions of the first sealing surface 12 may be closer to or further away from the second sealing surface 13 while being positioned on opposite sides of the body 11.

In some embodiments, the body 11 may comprise a first perimeter 14 and/or a second perimeter 15 which may be proximate to or continuous with the edge 16 of the body 11. The edge 16 may form the boundary between the first sealing surface 12 and second sealing surface 13 and the dimensions of which may be dictated by the thickness of the body 11. A first perimeter 14 may be formed into the first sealing surface 12 to extend around and be coupled with the edge 16. Likewise, a second perimeter 15 may be formed into the second sealing surface 13 to extend around and be coupled with the edge 16.

The body 11 may be made from or include a resilient material which is flexible to allow slight deformation and resilient so as to return to its original shape after deformation which also capable of functioning as an electrical insulator. For example, the body 11 may be made from a sheet of natural and/or synthetic rubber or from a sheet of any suitable resilient material. All or portions of the body 11 which are made from a resilient material may be compressed between objects, such as between a female electrical connector 210 and a male electrical connector 220, thereby allowing all or portions of the body 11 to form or function as a seal between the two objects. In some embodiments, all or portions of the first sealing surface 12, such as a first perimeter 14, may be made from or comprise a resilient material. In further embodiments, all or portions of the second sealing surface 13, such as a second perimeter 15, may be made from or comprise a resilient material. In still further embodiments, portions of the body 11 may be formed by a generally rigid material such as hard rubber or plastic while all or portions of the first sealing surface 12 and/or second sealing surface 13 may be made from a resilient material.

A resilient material which may be used to form all or portions of the body 11, such as the first sealing surface 12, second sealing surface 13, first perimeter 14, and/or second perimeter 15, and may comprise a Shore hardness of approximately 10 to 50 durometer preferably using the ASTM D2240 type A scale or equivalent. In some embodiments, a resilient material may be a natural and/or synthetic rubber material, which is flexible to allow slight deformation and resilient so as to return to its original shape after deformation. Natural rubber materials may include latex rubber, forms of the organic compound isoprene, such as polyisoprene, and the like. Synthetic rubber materials may include Polyacrylate Rubber, Ethylene-acrylate Rubber, Polyester Urethane, Bromo Isobutylene Isoprene, Polybutadiene, Chloro Isobutylene Isoprene, Polychloroprene, Chlorosulphonated Polyethylene, Epichlorohydrin, Ethylene Propylene, Ethylene Propylene Diene Monomer, Polyether Urethane, Perfluorocarbon Rubber, Fluoronated Hydrocarbon, Fluoro Silicone, Fluorocarbon Rubber, Hydrogenated Nitrile Butadiene, Polyisoprene, Isobutylene Isoprene Butyl, Acrylonitrile Butadiene, Polyurethane, Styrene Butadiene, Styrene Ethylene Butylene Styrene Copolymer, Polysiloxane, Vinyl Methyl Silicone, Acrylonitrile Butadiene Carboxy Monomer, Styrene Butadiene Carboxy Monomer, Thermoplastic Polyether-ester, Styrene Butadiene Block Copolymer, Styrene Butadiene Carboxy Block Copolymer, and the like. In other embodiments, a resilient material may be a flexible plastic such as polytetrafluoroethylene (PTFE), polyethylene terephthalate (PET), high-density polyethylene (HDPE), polyvinyl chloride (PVC), polypropylene (PP), Polystyrene (PS), Polycarbonate (PC), low density polyethylene (LDPE), Polyoxymethylene (POM), Acrylonitrile butadiene styrene (ABS), Polyethylene/Acrylonitrile Butadiene Styrene (PE/ABS), Polycarbonate/Acrylonitrile Butadiene Styrene (PC/ABS), Ultra High Molecular Weight polyethylene, Polyurethanes (PU), Polyamides (PA), or any other suitable flexible natural or synthetic material including combinations of materials, which is flexible to allow slight deformation and resilient so as to return to its original shape after deformation.

In some preferred embodiments, the body 11 may comprise platinum cured silicone with a Shore hardness of between 25 and 35 durometer. In further embodiments, the body 11 may be formed from platinum cured silicone with a Shore hardness of between 25 and 35 durometer, and more preferably approximately 30 durometer, that has been molded to form a first sealing surface 12 and second sealing surface 13. In still further embodiments, the first sealing surface 12 and/or second sealing surface 13 may be made from or comprise platinum cured silicone with a Shore hardness of between 25 and 35 durometer. Platinum cured silicone may comprise silicone that has been be cured, vulcanized, or catalyzed using platinum as catalyst, whereby two different chemical groups react, a silicone hydride and a vinyl. In this reaction, an ethyl group [C(H2)-C(H2)] is formed and there are no byproducts. Two separate components must be mixed to catalyze the polymers: the one component contains a platinum complex which must be mixed with the second, a hydride- and a vinyl-functional siloxane polymer, creating an ethyl bridge between the two.

Referring now to FIGS. 1-4, in some embodiments, the device 100 may comprise a first connection slot 21, second connection slot 22, and a third connection slot 23 which may be formed into the body 11 within the first sealing surface 12 and second sealing surface 13. The device 100 may be used with an electrical connector system 200 comprising a female electrical connector and a male electrical connector 220. The male electrical connector 220 may comprise a male mating surface 225 into which a first male prong 221, a second male prong 222, and a third male prong 223 may be coupled. The female electrical connector 210 may comprise a female mating surface 211 with one or more female prong receptacles. As is common in the art, a female electrical connector 210 may be mated with the male electrical connector 220 and comprise a complementary female prong receptacle suitable for receiving each male prong 221, 222, 223, thereby providing electrical connection between the female 210 and male 220 electrical connectors when mated as shown in FIG. 4. The connection slots 21, 22, 23, of the device 100 may be spaced apart and shaped in a complementary fashion as the male prongs 221, 222, 223, so that each male prong 221, 222, 223, may be received by a connection slot 21, 22, 23. In this and preferred embodiments, the first sealing surface 12 and second sealing surface 13 may be complimentary in shape to the female mating surface 211 and/or the male mating surface 225.

With respect to FIGS. 5-8, in some embodiments, the device 100 may comprise a first connection slot 21, second connection slot 22, and a third connection slot 23 which may be formed into the body 11 within the first sealing surface 12 and second sealing surface 13. The device 100 may be used with an electrical connector system 200 comprising a female electrical connector and a male electrical connector 220. The male electrical connector 220 may comprise a male mating surface 225 into which a first male prong 221, a second male prong 222, and a third male prong 223 may be coupled. The female electrical connector 210 may comprise a female mating surface 211 with one or more female prong receptacles. As is common in the art, a female electrical connector 210 may be mated with the male electrical connector 220 and comprise a complementary female prong receptacle suitable for receiving each male prong 221, 222, 223, thereby providing electrical connection between the female 210 and male 220 electrical connectors when mated as shown in FIG. 8. The connection slots 21, 22, 23, of the device 100 may be spaced apart and shaped in a complementary fashion as the male prongs 221, 222, 223, so that each male prong 221, 222, 223, may be received by a connection slot 21, 22, 23. In this and preferred embodiments, the first sealing surface 12 and second sealing surface 13 may be complimentary in shape to the female mating surface 211 and/or the male mating surface 225.

Additionally, the device 100 may comprise an optional electrical connector coupling 17 which may be used to couple the body 11 of the device 100 to the electrical connector system 200. Generally, an electrical connector coupling 17 may be formed by a length of material which may be coupled to the body 11 at a first end 18 and coupled to the electrical connector system 200 at a second end 19. In some embodiments, the second end 19 may be coupled to the electrical connector system 200 by being integrally formed, welded, or otherwise coupled to the electrical connector system 200. In alternative embodiments, the second end 19 may comprise a connector 20 which may couple or removably couple the second end 19 to the electrical connector system 200.

Preferably an electrical connector coupling 17 may secure the device 100 to an element or portion of an electrical connector system 200, such as a male electrical connector 220 or the female electrical connector 210, to prevent the device 100 from becoming lost or separated from the electrical connector system 200 when not in use. As is common in the art, electrical connectors 210, 220, are coupled to wiring 230 and optionally, an electrical connector coupling 17 may secure the device 100 to the wiring 230 of one or both electrical connectors 210, 220. As shown in the examples of FIGS. 5-8 and 13-16, in some embodiments, a connector 20 may comprise a loop of material 20 which may encircle a portion of an electrical connector system 200, such as a portion of the male electrical connector 220 or the female electrical connector 210. In alternative embodiments, a connector 20 may comprise any type of fastener which may be used to couple or removably couple the electrical connector coupling 17 to any element or portion of an electrical connector system 200. In further embodiments, the electrical connector coupling 17 may be made from or comprise a resilient material, a flexible material such as fabric or cloth, a rigid material, such as hard plastic or rubber, or any other suitable material.

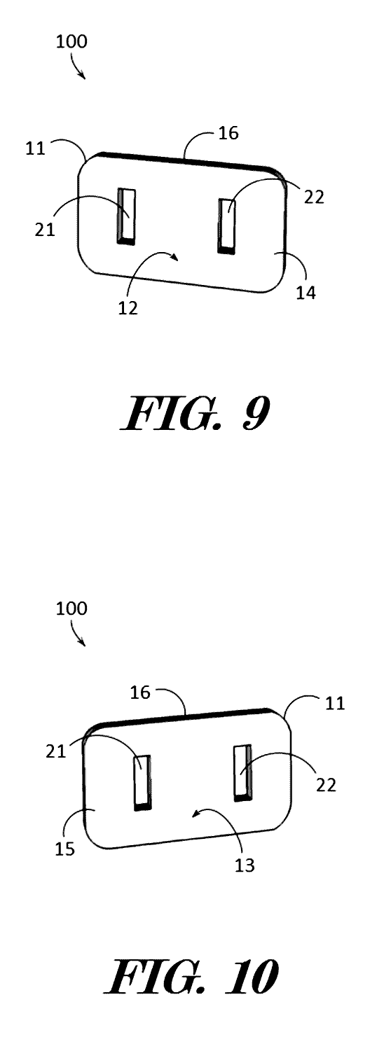

As depicted in FIGS. 9-12, in some embodiments, the device 100 may comprise a first connection slot 21 and second connection slot 22 which may be formed into the body 11 within the first sealing surface 12 and second sealing surface 13. The device 100 may be used with an electrical connector system 200 comprising a female electrical connector and a male electrical connector 220. The male electrical connector 220 may comprise a male mating surface 225 into which a first male prong 221 and a second male prong 222 may be coupled. The female electrical connector 210 may comprise a female mating surface 211 with one or more female prong receptacles. As is common in the art, a female electrical connector 210 may be mated with the male electrical connector 220 and comprise a complementary female prong receptacle suitable for receiving each male prong 221, 222, thereby providing electrical connection between the female 210 and male 220 electrical connectors when mated as shown in FIG. 12. The connection slots 21, 22, of the device 100 may be spaced apart and shaped in a complementary fashion as the male prongs 221, 222, so that each male prong 221, 222, may be received by a connection slot 21, 22. In this embodiment, the first sealing surface 12 and second sealing surface 13 may be complimentary in shape to the male mating surface 225.

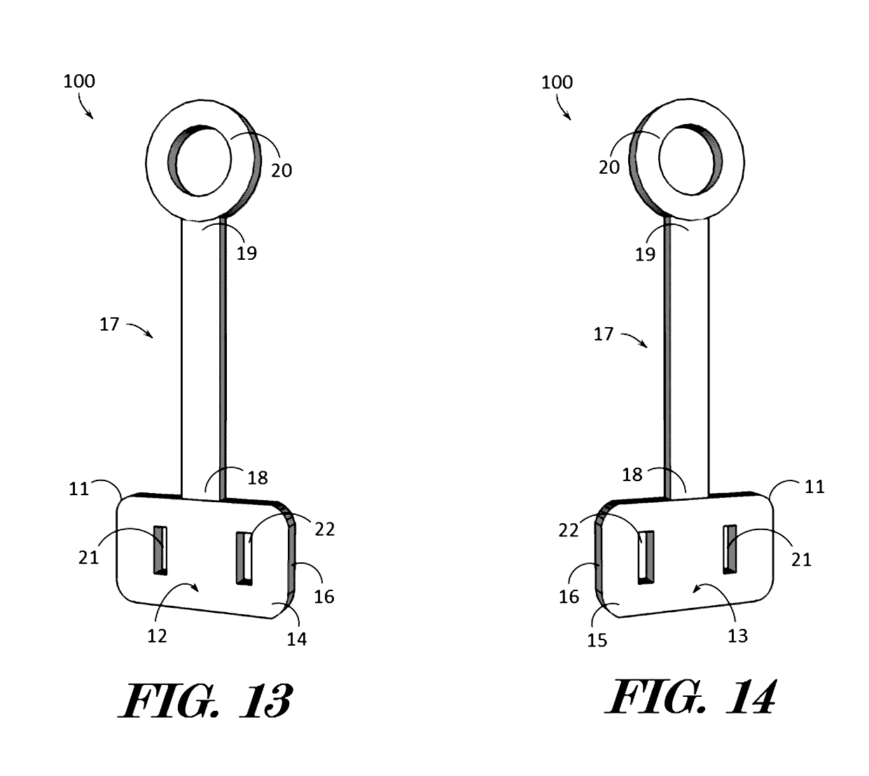

Turning now to FIGS. 13-16, in some embodiments, the device 100 may comprise a first connection slot 21 and second connection slot 22 which may be formed into the body 11 within the first sealing surface 12 and second sealing surface 13. Additionally, the device 100 may comprise an optional electrical connector coupling 17 which may be used to couple the body 11 of the device 100 to the electrical connector system 200. Preferably the electrical connector coupling 17 may secure the device 100 to an element or portion of an electrical connector system 200, such as a male electrical connector 220 or the female electrical connector 210, to prevent the device 100 from becoming lost or separated from the electrical connector system 200 when not in use. The device 100 may be used with an electrical connector system 200 comprising a female electrical connector and a male electrical connector 220. The male electrical connector 220 may comprise a male mating surface 225 into which a first male prong 221 and a second male prong 222 may be coupled. The female electrical connector 210 may comprise a female mating surface 211 with one or more female prong receptacles. As is common in the art, a female electrical connector 210 may be mated with the male electrical connector 220 and comprise a complementary female prong receptacle suitable for receiving each male prong 221, 222, thereby providing electrical connection between the female 210 and male 220 electrical connectors when mated as shown in FIG. 16. The connection slots 21, 22, of the device 100 may be spaced apart and shaped in a complementary fashion as the male prongs 221, 222, so that each male prong 221, 222, may be received by a connection slot 21, 22. In this embodiment, the first sealing surface 12 and second sealing surface 13 may be complimentary in shape to the male mating surface 225.

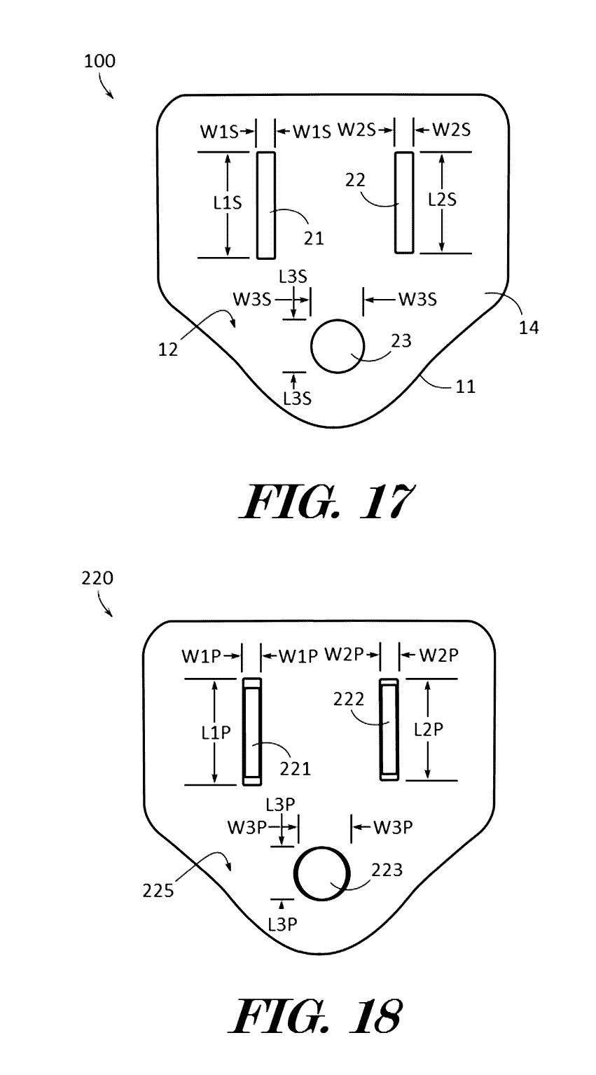

FIG. 17 illustrates an elevation view of an example of an electrical connection weatherproofing device 100, and FIG. 18 shows an elevation view of an example of a male electrical connector 220 according to various embodiments described herein. In this example, the device 100 may comprise a first connection slot 21, second connection slot 22, and a third connection slot 23 which may be formed into the body 11 within the first sealing surface 12. The male electrical connector 220 may comprise a male mating surface 225 into which a first male prong 221, a second male prong 222, and a third male prong 223 may be coupled.

The first male prong 221 may comprise a length dimension (L1P) and a width dimension (W1P). Likewise, the first connection slot 21 may comprise a length dimension (L1S) and a width dimension (W1S). In preferred embodiments, the dimensions of the first connection slot 21 may be configured to be complimentary to the dimensions of the first male prong 221 so that they are similar or complimentary in shape to each other. For example, the ratio of L1S to L1P may be substantially equal (plus or minus two percent) to the ratio of W1S to W1P. In further embodiments, the first connection slot 21 may be larger in size or shape than the first male prong 221 so that the L1S is greater than the L1P and/or the W1S is greater than the W1P of the first male prong 221. In alternative embodiments, the first connection slot 21 may be substantially equal in size or shape to the first male prong 221 so that the L1S is substantially equal (plus or minus two percent) to the L1P and/or the W1S is substantially equal (plus or minus two percent) to the W1P of the first male prong 221. In further alternative embodiments, the first connection slot 21 may be smaller in size or shape than the first male prong 221 so that the L1S is less than the L1P and/or the W1S is less than the W1P of the first male prong 221 thereby allowing the first connection slot 21 to be frictionally retained on the first male prong 221.

In some embodiments, the length dimension (L1P) and width dimension (W1P) of the first male prong 221 may be used to calculate a cross sectional area (A1P) of the first male prong 221. For example, for a first male prong 221 with a generally rectangular cross sectional shape, the A1P may be calculated by multiplying L1P by W1P. In another example, the A1P of a circular shaped male prong 221 may be calculated by pi (it) multiplied by one half L1P or W1P. Likewise, the length dimension (L1S) and width dimension (W1S) of the first connection slot 21 may be used to calculate a cross sectional area (A1S) of the first connection slot 21. For example, for a first connection slot 21 with a generally rectangular cross sectional shape, the A1S may be calculated by multiplying L1S by W1S. In another example, the A1S of a circular shaped first connection slot 21 may be calculated by pi (it) multiplied by one half L1S or W1S. In further embodiments, the A1S of the first connection slot 21 may be larger than the A1P of the first male prong 221. In alternative embodiments, the A1S of the first connection slot 21 may be substantially equal to the A1P of the first male prong 221 so that the A1S of the first connection slot 21 is substantially equal (plus or minus two percent) to the A1P of the first male prong 221. In further alternative embodiments, the A1S of the first connection slot 21 may be smaller than the A1P of the first male prong 221 thereby allowing the first connection slot 21 to be frictionally retained on the first male prong 221.

The second male prong 222 may comprise a length dimension (L2P) and a width dimension (W2P). Similarly, the second connection slot 22 may comprise a length dimension (L2S) and a width dimension (W2S). In preferred embodiments, the dimensions of the second connection slot 22 may be configured to be complimentary to the dimensions of the second male prong 222 so that they are similar or complimentary in shape to each other. For example, the ratio of L2S to L2P may be substantially equal (plus or minus two percent) to the ratio of W2S to W2P. In further embodiments, the second connection slot 22 may be larger in size or shape than the second male prong 222 so that the L2S is greater than the L2P and/or the W2S is greater than the W2P of the second male prong 222. In alternative embodiments, the second connection slot 22 may be substantially equal in size or shape to the second male prong 222 so that the L2S is substantially equal (plus or minus two percent) to the L2P and/or the W2S is substantially equal (plus or minus two percent) to the W2P of the second male prong 222. In further alternative embodiments, the second connection slot 22 may be smaller in size or shape than the second male prong 222 so that the L2S is less than the L2P and/or the W2S is less than the W2P of the second male prong 222 thereby allowing the second connection slot 22 to be frictionally retained on the second male prong 222.

In some embodiments, the length dimension (L2P) and width dimension (W2P) of the second male prong 222 may be used to calculate a cross sectional area (A2P) of the second male prong 222. For example, for a second male prong 222 with a generally rectangular cross sectional shape, the A2P may be calculated by multiplying L2P by W2P. In another example, the A2P of a circular shaped second male prong 222 may be calculated by pi (it) multiplied by one half L2P or W2P. Likewise, the length dimension (L2S) and width dimension (W2S) of the second connection slot 22 may be used to calculate a cross sectional area (A2S) of the second connection slot 22. For example, for a second connection slot 22 with a generally rectangular cross sectional shape, the A2S may be calculated by multiplying L2S by W2S. In another example, the A2S of a circular shaped second connection slot 21 may be calculated by pi (it) multiplied by one half L2S or W2S. In further embodiments, the A2S of the second connection slot 22 may be larger than the A2P of the second male prong 222. In alternative embodiments, the A2S of the second connection slot 22 may be substantially equal to the A2P of the second male prong 222 so that the A2S of the second connection slot 22 is substantially equal (plus or minus two percent) to the A2P of the second male prong 222. In further alternative embodiments, the A2S of the second connection slot 22 may be smaller than the A2P of the second male prong 222 thereby allowing the second connection slot 22 to be frictionally retained on the second male prong 222.

The third male prong 223 may comprise a length dimension (L3P) and a width dimension (W3P). Similarly, the optional third connection slot 23 may comprise a length dimension (L3S) and a width dimension (W3S). In preferred embodiments, the dimensions of the third connection slot 23 may be configured to be complimentary to the dimensions of the third male prong 223 so that they are similar or complimentary in shape to each other. For example, the ratio of L3S to L3P may be substantially equal (plus or minus two percent) to the ratio of W3 S to W3P. In further embodiments, an optional third connection slot 23 may be larger in size or shape than a third male prong 223 so that the L3 S is greater than the L3P and/or the W3S is greater than the W3P of the third male prong 223. In alternative embodiments, the third connection slot 23 may be substantially equal in size or shape to the third male prong 223 so that the L3S is substantially equal (plus or minus two percent) to the L3P and/or the W3S is substantially equal (plus or minus two percent) to the W3P of the third male prong 223. In further alternative embodiments, the third connection slot 23 may be smaller in size or shape than the third male prong 223 so that the L3S is less than the L3P and/or the W3S is less than the W3P of the third male prong 223 thereby allowing the third connection slot 23 to be frictionally retained on the third male prong 223.

In some embodiments, the length dimension (L3P) and width dimension (W3P) of a third male prong 233 may be used to calculate a cross sectional area (A3P) of the third male prong 233. For example, for a third male prong 223 with a generally rectangular cross sectional shape, the A3P may be calculated by multiplying L3P by W3P. In another example, the A3P of a circular shaped third male prong 223 may be calculated by pi (it) multiplied by one half L3P or W3P. Likewise, the length dimension (L3S) and width dimension (W3S) of an optional third connection slot 23 may be used to calculate a cross sectional area (A3S) of the third connection slot 23. For example, for a third connection slot 23 with a generally rectangular cross sectional shape, the A3S may be calculated by multiplying L3S by W3S. In another example, the A3S of a circular shaped third connection slot 23 may be calculated by pi (it) multiplied by one half L3S or W3S. In further embodiments, the A3S of the third connection slot 23 may be larger than the A3P of the third male prong 233. In alternative embodiments, the A3S of the third connection slot 23 may be substantially equal to the A3P of the third male prong 233 so that the A3S of the third connection slot 23 is substantially equal (plus or minus two percent) to the A3P of the third male prong 233. In further alternative embodiments, the A3S of the third connection slot 23 may be smaller than the A3P of the third male prong 233 thereby allowing the third connection slot 23 to be frictionally retained on the third male prong 233.

While some embodiments depicted herein show the electrical connection weatherproofing device 100 comprising a first connection slot 21, a second connection slot 22, and an optional third connection slot 23, in further embodiments, the device 100 may comprise an optional fourth connection slot, an optional fifth connection slot, an optional sixth connection slot, and/or any other number of connection slots. Additionally, while the first connection slot 21 and second connection slot 22 may be configured with a generally rectangular shape and a third connection slot 23 may be configured with a generally circular shape, it should be understood to one of ordinary skill in the art that the first connection slot 21, second connection slot 22, and/or optional third connection slot 23 may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. Likewise, the first sealing surface 12 and/or second sealing surface 13, and therefore the body 11, may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

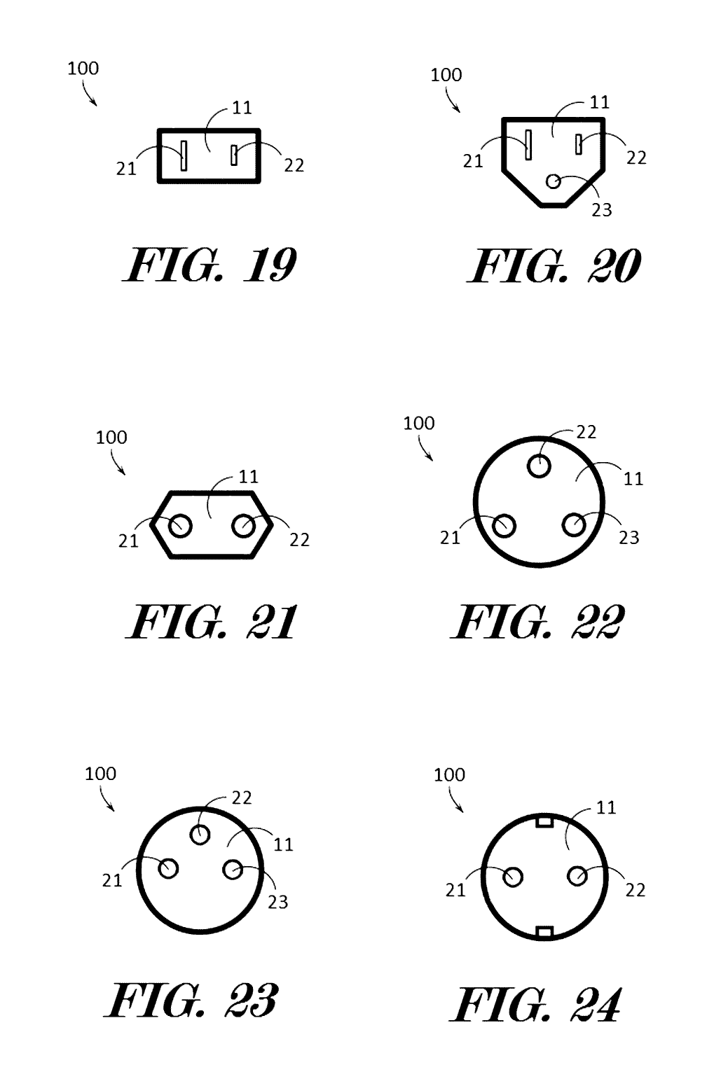

As perhaps best illustrated in FIGS. 19-30, the body 11, and therefore the first 12 and second 13 sealing surfaces of the body 11, the first connection slot 21, second connection slot 22, and optional third connection slot 23 may be configured in a plurality of shapes and sizes. Additionally, the first connection slot 21, second connection slot 22, and optional third connection slot 23 may be oriented or positioned anywhere on the body to allow the device 100 to be used with a electrical connector system 200 (FIGS. 5-12) comprising a female electrical connector 210 and male electrical connector 220. In this manner, the device 100 may be configured to be used with electrical connector systems 200 of any type such as those listed in the International Electrotechnical Commission (IEC) technical report TR 60083.

FIG. 19 depicts an elevation view of an example of an electrical connection weatherproofing device 100 comprising a body 11 with a first connection slot 21 and second connection slot 22 configured for use with a type A electrical connector system according to various embodiments described herein.

FIG. 20 illustrates an elevation view of an example of an electrical connection weatherproofing device 100 comprising a body 11 with a first connection slot 21, second connection slot 22, and third connection slot 23 configured for use with a type B electrical connector system according to various embodiments described herein.

FIG. 21 shows an elevation view of an example of an electrical connection weatherproofing device 100 comprising a body 11 with a first connection slot 21 and second connection slot 22 configured for use with a type C electrical connector system according to various embodiments described herein.

FIG. 22 depicts an elevation view of an example of an electrical connection weatherproofing device 100 comprising a body 11 with a first connection slot 21, second connection slot 22, and third connection slot 23 configured for use with a type D electrical connector system according to various embodiments described herein.

FIG. 23 illustrates an elevation view of an example of an electrical connection weatherproofing device 100 comprising a body 11 with a first connection slot 21, second connection slot 22, and third connection slot 23 configured for use with a type E electrical connector system according to various embodiments described herein.

FIG. 24 shows an elevation view of an example of an electrical connection weatherproofing device 100 comprising a body 11 with a first connection slot 21 and second connection slot 22 configured for use with a type F electrical connector system according to various embodiments described herein.

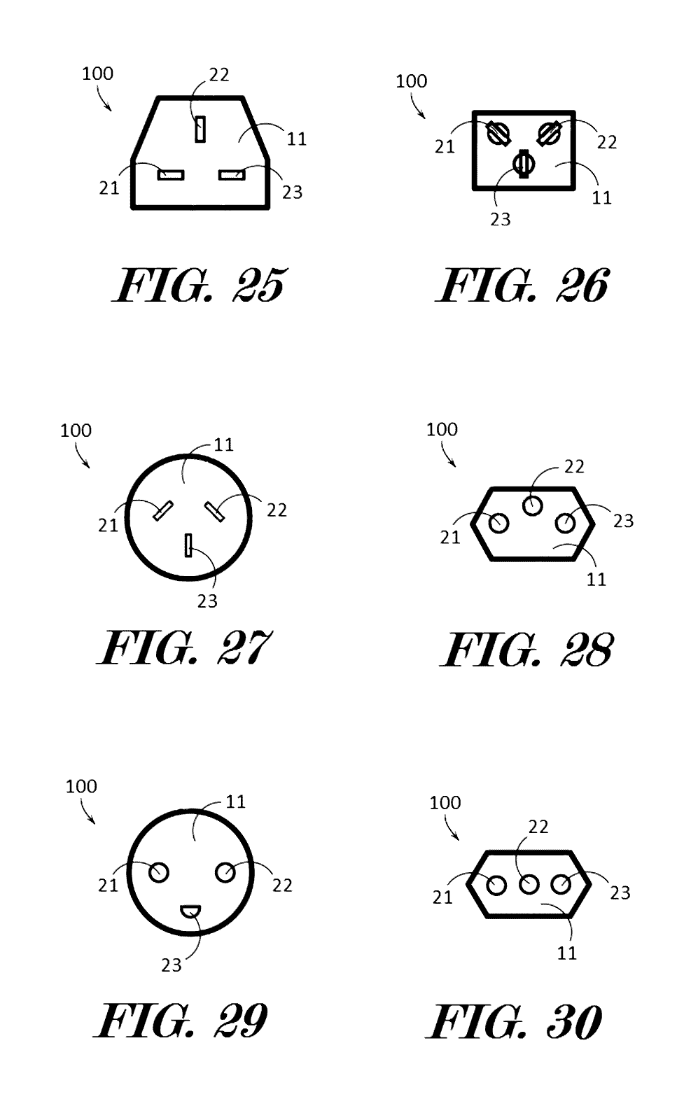

FIG. 25 depicts an elevation view of an example of an electrical connection weatherproofing device 100 comprising a body 11 with a first connection slot 21, second connection slot 22, and third connection slot 23 configured for use with a type G electrical connector system according to various embodiments described herein.

FIG. 26 illustrates an elevation view of an example of an electrical connection weatherproofing device 100 comprising a body 11 with a first connection slot 21, second connection slot 22, and third connection slot 23 configured for use with a type H electrical connector system according to various embodiments described herein.

FIG. 27 shows an elevation view of an example of an electrical connection weatherproofing device 100 comprising a body 11 with a first connection slot 21, second connection slot 22, and third connection slot 23 configured for use with a type I electrical connector system according to various embodiments described herein.

FIG. 28 depicts an elevation view of an example of an electrical connection weatherproofing device 100 comprising a body 11 with a first connection slot 21, second connection slot 22, and third connection slot 23 configured for use with a type J electrical connector system according to various embodiments described herein.

FIG. 29 illustrates an elevation view of an example of an electrical connection weatherproofing device 100 comprising a body 11 with a first connection slot 21, second connection slot 22, and third connection slot 23 configured for use with a type K electrical connector system according to various embodiments described herein.

FIG. 30 shows an elevation view of an example of an electrical connection weatherproofing device 100 comprising a body 11 with a first connection slot 21, second connection slot 22, and third connection slot 23 configured for use with a type L electrical connector system according to various embodiments described herein.

While some materials have been provided, in other embodiments, the elements that comprise the device 100 such as the body 11, first sealing surface 12, second sealing surface 13, first perimeter 14, second perimeter 15, optional electrical connector coupling 17, and/or any other element discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be removably coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An electrical connection weatherproofing device for use with a male electrical connector comprising a base mating surface into which a first male prong and a second male prong are coupled, the device comprising:
a body forming a first sealing surface and a second sealing surface;
a first connection slot disposed within the body, wherein the first connection slot is complementary in shape to the shape of the first male prong; and
a second connection slot disposed within the body, wherein the second connection slot is complementary in shape to the shape of the second male prong.

2. The device of claim 1, wherein the first sealing surface has a Shore hardness of between 10 and 50 durometer.

3. The device of claim 1, wherein the second sealing surface has a Shore hardness of between 10 and 50 durometer.

4. The device of claim 1, wherein the body comprises platinum cured silicone with a Shore hardness of between 25 and 35 durometer.

5. The device of claim 1, wherein the first connection slot comprises a cross sectional area (A1S), wherein the first male prong comprises a cross sectional area (A1P), and wherein A1 S is substantially equal to A1P.

6. The device of claim 1, wherein the second connection slot comprises a cross sectional area (A2S), wherein the second male prong comprises a cross sectional area (A2P), and wherein A2S is substantially equal to A2P.

7. The device of claim 1, further comprising a third connection slot disposed within the body, wherein the third connection slot is complementary in shape to the shape of a third male prong of the male electrical connector.

8. The device of claim 6, wherein the third connection slot comprises a cross sectional area (A3S), wherein the third male prong comprises a cross sectional area (A3P), and wherein A3S is substantially equal to A3P.

9. The device of claim 1, wherein the first sealing surface has a first perimeter, and wherein the first perimeter has a Shore hardness of between 10 and 50 durometer.

10. The device of claim 1, wherein the second sealing surface has a second perimeter, and wherein the second perimeter has a Shore hardness of between 10 and 50 durometer.

11. An electrical connection weatherproofing device for use with an electrical connector system, the system comprising a female electrical connector and a male electrical connector that is configured to be removably coupled to the female electrical connector, wherein the male electrical connector comprises a male mating surface into which a first male prong and a second male prong are coupled, and the device comprising:
a body forming a first sealing surface and a second sealing surface;
a first connection slot disposed within the body, wherein the first connection slot is complementary in shape to the shape of the first male prong;
a second connection slot disposed within the body, wherein the second connection slot is complementary in shape to the shape of the second male prong; and
an electrical connector coupling for coupling the body of the device to the electrical connector system.

12. The device of claim 11, wherein the first sealing surface has a Shore hardness of between 10 and 50 durometer.

13. The device of claim 11, wherein the second sealing surface has a Shore hardness of between 10 and 50 durometer.

14. The device of claim 11, wherein the body comprises platinum cured silicone with a Shore hardness of between 25 and 35 durometer.

15. The device of claim 11, wherein the first connection slot comprises an area (A1S), wherein the first male prong comprises an area (A1P), and wherein A1 S is substantially equal to A1P.

16. The device of claim 11, wherein the second connection slot comprises an area (A2S), wherein the second male prong comprises an area (A2P), and wherein A2S is substantially equal to A2P.

17. The device of claim 11, further comprising a third connection slot disposed within the body, wherein the third connection slot is complementary in shape to the shape of a third male prong of the male electrical connector.

18. The device of claim 16, wherein the third connection slot comprises an area (A3S), wherein the third male prong comprises an area (A3P), and wherein A3S is substantially equal to A3P.

19. The device of claim 11, wherein the first sealing surface has a first perimeter, and wherein the first perimeter has a Shore hardness of between 10 and 50 durometer.

20. The device of claim 11, wherein the second sealing surface has a second perimeter, and wherein the second perimeter has a Shore hardness of between 10 and 50 durometer.
